(19) United States
(12) Patent Application Publication
(10) Pub. No.: US 2026/0078469 A1
(43) Pub. Date: Mar. 19, 2026

(54) ALLOY THERMAL FUSE

(71) Applicant: Xiamen PVTECH Co., Ltd., Xiamen (CN)

(72) Inventors: RONGTU LIU, Xiamen (CN); CHUNMING LIU, Xiamen (CN); CHENGHAO ZUO, Xiamen (CN); FUXING LU, Xiamen (CN)

(21) Appl. No.: 19/329,590

(22) Filed: Sep. 16, 2025

(30) Foreign Application Priority Data
Sep. 19, 2024 (CN) 202411310656.3

(51) Int. Cl. C22C 13/00; H01H 85/06

(52) U.S. Cl. CPC C22C 13/00; H01H 85/06

(57) ABSTRACT

An alloy thermal fuse is provided, which is made of an alloy material, and the alloy material includes tin, lead, bismuth, antimony, and nickel. The weight percentage of the tin is 62% to 63.5%. The weight percentage of the lead is 36% to 37%. The weight percentage of the bismuth is 0.0001% to 0.5%. The weight percentage of the antimony is 0.0001% to 0.3%. The weight percentage of the nickel is 0.0001% to 0.3%. Via the above specific component proportion, the alloy thermal fuse exhibits uniform heating when exposed to heat and has higher sensitivity to temperature changes, which can enhance the thermal conductivity thereof. Thus, the alloy thermal fuse can melt quickly when heated. Moreover, since the alloy thermal fuse is an elongated alloy without an insulating casing or other complex components, the alloy thermal fuse does not experience heat loss caused by various media.

### TECHNICAL FIELD

The disclosure relates to a thermal fuse, in particular to an alloy thermal fuse.

### BACKGROUND

Generally, a currently available cartridge-type thermal fuse has one of its terminals inserted into a circuit board, followed by wave soldering, and the fuse body is fixed to a heating device or other heat-prone components (such as pins). In this way, the cartridge-type thermal fuse can be placed between the protected circuit and the power supply network. However, the cartridge-type thermal fuse still has several shortcomings which need to be further improved.

For example, the alloy material of the cartridge-type thermal fuse is prone to melting during wave soldering when the alloy material reaches the melting point thereof, causing the cartridge-type thermal fuse to lose the protective function prematurely. Similarly, the cartridge-type thermal fuse has an insulating casing and other complex components, which are susceptible to heat loss due to various media.

Additionally, during the installation process of the cartridge-type thermal fuse, the user must perform at least one shaping step on the alloy material (adjusting the shape of the alloy material), and the pins connecting the fuse to the circuit board require insulation treatment. Moreover, the distance between the terminals and the circuit board must be further adjusted, which may require an additional shaping step. Furthermore, the cartridge-type thermal fuse also needs to be secured to the circuit board using adhesive. These factors collectively increase the complexity of installing the cartridge-type thermal fuse.

### SUMMARY

One embodiment of the disclosure provides an alloy thermal fuse, which is made of an alloy material. The alloy material includes tin, lead, bismuth, antimony, and nickel. The weight percentage of the tin is 62% to 63.5%. The weight percentage of the lead is 36% to 37%. The weight percentage of the bismuth is 0.0001% to 0.5%. The weight percentage of the antimony is 0.0001% to 0.3%. The weight percentage of the nickel is 0.0001% to 0.3%.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF DRAWINGS

The disclosure will become more fully understood from the detailed description given herein below and the accompanying drawings which are given by way of illustration only, and thus are not limitative of the disclosure and wherein:

FIG. 1 is a first schematic view of an installation process of an alloy thermal fuse in accordance with a first embodiment of the disclosure.

FIG. 2 is a second schematic view of the installation process of the alloy thermal fuse in accordance with the first embodiment of the disclosure.

FIG. 3 is a third schematic view of the installation process of the alloy thermal fuse in accordance with the first embodiment of the disclosure.

FIG. 4 is a fourth schematic view of the installation process of the alloy thermal fuse in accordance with the first embodiment of the disclosure.

FIG. 5 is a flow chart of an installation method of an alloy thermal fuse in accordance with a second embodiment of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing. It should be understood that, when it is described that an element is “coupled” or “connected” to another element, the element may be “directly coupled” or “directly connected” to the other element or “coupled” or “connected” to the other element through a third element. In contrast, it should be understood that, when it is described that an element is “directly coupled” or “directly connected” to another element, there are no intervening elements.

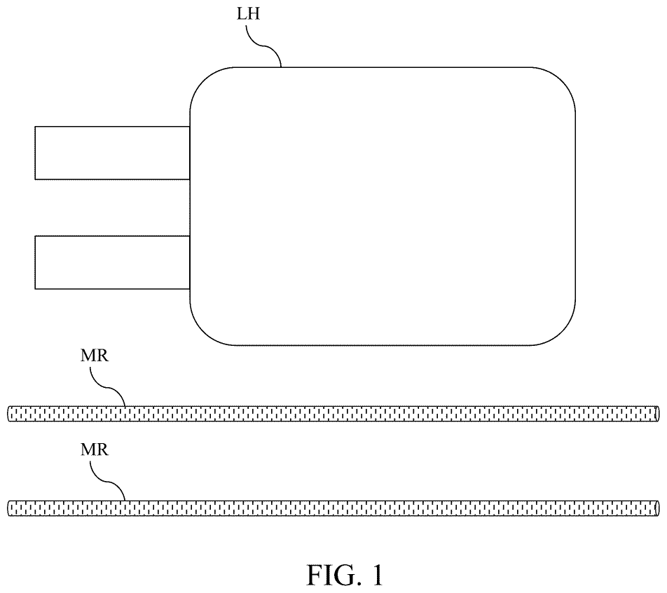

Please refer to FIG. 1, which is a first schematic view of an installation process of an alloy thermal fuse in accordance with a first embodiment of the disclosure. As shown in FIG. 1, the user can cut the alloy materials MR to an appropriate length using automated equipment. In this embodiment, the alloy materials MR are cut to a length matching the end cap LH.

The embodiment just exemplifies the disclosure and is not intended to limit the scope of the disclosure; any equivalent modification and variation according to the spirit of the disclosure is to be also included within the scope of the following claims and their equivalents.

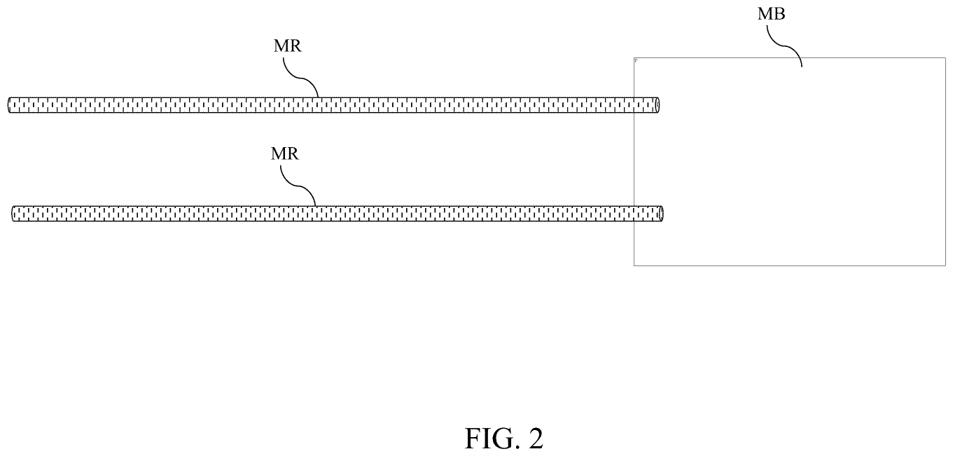

Please refer to FIG. 2, which is a second schematic view of the installation process of the alloy thermal fuse in accordance with the first embodiment of the disclosure. As shown in FIG. 2, the user can perform wave soldering on the circuit board MB, which may be a power supply or a semi-finished product, and then use general automated soldering equipment to solder the alloy materials MR onto the pads of the circuit board MB.

The embodiment just exemplifies the disclosure and is not intended to limit the scope of the disclosure; any equivalent modification and variation according to the spirit of the disclosure is to be also included within the scope of the following claims and their equivalents.

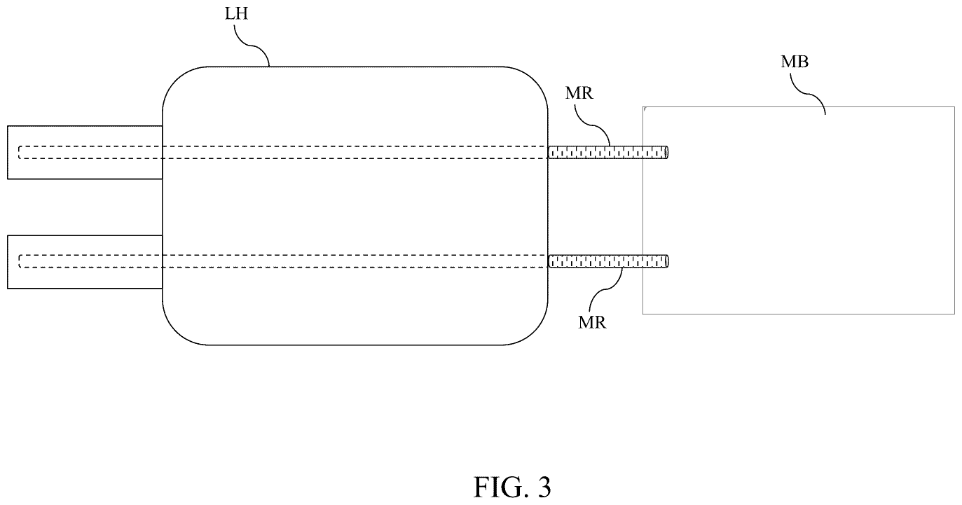

Please refer to FIG. 3, which is a third schematic view of the installation process of the alloy thermal fuse in accordance with the first embodiment of the disclosure. As shown in FIG. 3, the user can insert the alloy materials MR into the pins of the end cap LH, then perform riveting and trim the excessive portion of the alloy materials MR.

The embodiment just exemplifies the disclosure and is not intended to limit the scope of the disclosure; any equivalent modification and variation according to the spirit of the disclosure is to be also included within the scope of the following claims and their equivalents.

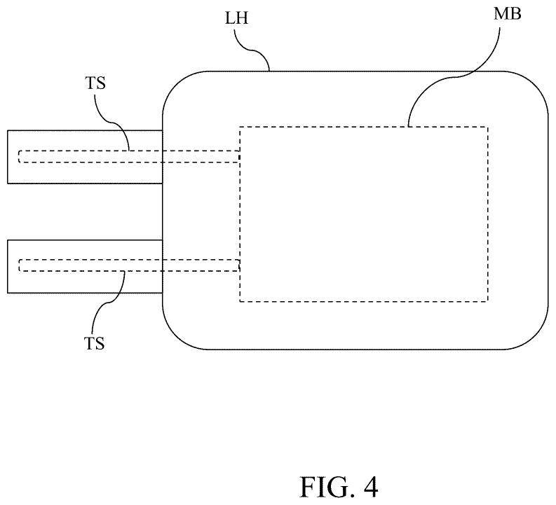

Please refer to FIG. 4, which is a fourth schematic view of the installation process of the alloy thermal fuse in accordance with the first embodiment of the disclosure. As shown in FIG. 4, the alloy materials MR can then serve as the alloy thermal fuses TS to provide temperature protection.

This embodiment discloses the alloy thermal fuse TS made of alloy material MR. The alloy material MR includes tin (Sn), lead (Pb), bismuth (Bi), antimony (Sb), and nickel (Ni). The weight percentage of tin is 62% to 63.5%. The weight percentage of lead is 36% to 37%. The weight percentage of bismuth is 0.0001% to 0.5%. The weight percentage of antimony is 0.0001% to 0.3%. The weight percentage of nickel is 0.0001% to 0.3%. The weight percentage of bismuth is greater than the weight percentages of antimony and nickel. The sum of the weight percentages of antimony and nickel is greater than the weight percentage of bismuth. For example, the weight percentage of tin is 63%; lead 36.5%; bismuth 0.2%; antimony 0.15%; nickel 0.15%. For example, tin 63.5%; lead 36.3%; bismuth 0.08%; antimony 0.07%; nickel 0.05%. For example, tin 63.5%; lead 36.3%; bismuth 0.09%; antimony 0.08%; nickel 0.03%. The specific gravity of the alloy material MR is between 7 and 8. The solidus temperature of the alloy material MR is between 181°and 185°. The liquidus temperature of the alloy material MR is between 181°and 185°.

Through the above specific component proportion, the alloy thermal fuse TS heats uniformly when exposed to heat and has higher sensitivity to temperature changes, thereby improving its thermal conductivity. Therefore, the alloy thermal fuse TS can quickly melt when heated. In addition, since the alloy thermal fuse TS has a structure of a single elongated alloy without an insulating casing or other complex components, the alloy thermal fuse TS does not experience heat loss caused by multiple media, further enhancing the technical effect.

Moreover, in this embodiment, the alloy thermal fuse TS can be directly soldered onto the circuit board MB or a semi-finished product, so the alloy thermal fuse TS will not prematurely lose the protective function thereof due to melting during wave soldering. In this way, the reliability of the alloy thermal fuse TS is greatly improved to ensure the alloy thermal fuse TS can properly provide temperature protection. Therefore, the alloy thermal fuse TS can meet actual requirements.

Additionally, in this embodiment, since the alloy thermal fuse TS has a structure of a single elongated alloy without an insulating casing or other complex components, the alloy thermal fuse TS does not need to be fixed to the circuit board MB using adhesive. Thus, the alloy thermal fuse TS can be installed using automated equipment, greatly reducing installation cost and complexity. Therefore, the alloy thermal fuse TS can be more comprehensive in application in order to meet the requirements of different application.

Furthermore, in this embodiment, the alloy thermal fuse TS has a structure of a single elongated alloy without an insulating casing or other complex components. Therefore, the size of the alloy thermal fuse TS can be very small and will not occupy internal space within the device. As a result, the device can be more compact, which not only reduces manufacturing costs but also saves transportation costs.

Moreover, in this embodiment, the alloy thermal fuse TS has a specific component proportion. This specific proportion allows the alloy thermal fuse TS to achieve excellent conductive performance. As such, the alloy thermal fuse TS can provide temperature protection not only when the circuit board MB overheats but also when the circuit board MB experiences overcurrent. Therefore, the safety of the alloy thermal fuse TS is greatly enhanced.

The embodiment just exemplifies the disclosure and is not intended to limit the scope of the disclosure; any equivalent modification and variation according to the spirit of the disclosure is to be also included within the scope of the following claims and their equivalents.

It is worthy to point out that the alloy material of the cartridge-type thermal fuse is prone to melting during wave soldering when the alloy material reaches the melting point thereof, causing the cartridge-type thermal fuse to lose the protective function prematurely. Similarly, the cartridge-type thermal fuse has an insulating casing and other complex components, which are susceptible to heat loss due to various media. Additionally, during the installation process of the cartridge-type thermal fuse, the user must perform at least one shaping step on the alloy material (adjusting the shape of the alloy material), and the pins connecting the fuse to the circuit board require insulation treatment. Moreover, the distance between the terminals and the circuit board must be further adjusted, which may require an additional shaping step. Furthermore, the cartridge-type thermal fuse also needs to be secured to the circuit board using adhesive. These factors collectively increase the complexity of installing the cartridge-type thermal fuse. By contrast, according to one embodiment of the present invention, the alloy thermal fuse TS is made of alloy material MR, and the alloy material MR includes tin, lead, bismuth, antimony, and nickel. The weight percentage of tin is 62% to 63.5%. The weight percentage of lead is 36% to 37%. The weight percentage of bismuth is 0.03% to 0.5%. The weight percentage of antimony is 0.03% to 0.3%. The weight percentage of nickel is 0.03% to 0.3%. The weight percentage of bismuth is greater than the weight percentages of antimony and nickel. The sum of the weight percentages of antimony and nickel is greater than the weight percentage of bismuth. Through the above specific component proportions, the alloy thermal fuse TS heats uniformly when exposed to heat, and exhibits higher sensitivity to temperature changes, thereby enhancing the thermal conductivity of the alloy thermal fuse TS. As a result, the alloy thermal fuse TS can melt quickly when heated. In addition, since the alloy thermal fuse TS has a structure of a single elongated alloy without an insulating casing or other complex components, the thermal fuse does not experience heat loss caused by various media, further improving the aforementioned technical effects.

According to one embodiment of the present invention, the alloy thermal fuse TS can be directly soldered onto a circuit board or semi-finished product, so the alloy thermal fuse TS will not prematurely lose the protective function thereof due to melting during wave soldering. Thus, the reliability of the alloy thermal fuse TS can be significantly enhanced to ensure that the alloy thermal fuse TS can properly provide temperature protection. Therefore, the alloy thermal fuse TS can meet practical application requirements.

Also, according to one embodiment of the present invention, the alloy thermal fuse TS has a structure of a single elongated alloy without an insulating casing or other complex components. The alloy thermal fuse TS also does not need to be fixed to the circuit board using adhesive. In this way, the alloy thermal fuse TS can be installed using automated equipment, greatly reducing installation cost and complexity. Therefore, the alloy thermal fuse TS can be more comprehensive in application, and can better meet the requirements of different applications.

In addition, according to one embodiment of the present invention, the alloy thermal fuse TS has a structure of a single elongated alloy without an insulating casing or other complex components. Therefore, the size of the alloy thermal fuse TS can be very small, without occupying internal space within the device. Consequently, the device can be more compact, which not only reduces manufacturing costs but also saves transportation costs.

Moreover, according to one embodiment of the present invention, the alloy thermal fuse TS has a specific component proportion. This specific component proportion allows the alloy thermal fuse TS to achieve excellent conductive performance. In this way, the alloy thermal fuse TS can provide temperature protection not only when the circuit board overheats but also when the circuit board experiences overcurrent. Therefore, the safety of the alloy thermal fuse TS can be greatly improved.

Furthermore, according to an embodiment of the present invention, the alloy thermal fuse TS can achieve the desired effect while reducing cost. As such, the practicality of the alloy thermal fuse TS can be significantly enhanced, and the alloy thermal fuse TS can be applied to various electronic devices while improving their safety. Therefore, the alloy thermal fuse TS can meet the trend of future development. As set forth above, the alloy thermal fuse TS according to the embodiments can definitely achieve great technical effects.

The second embodiment of the present invention discloses that the alloy material MR of the alloy thermal fuse TS not only includes tin, lead, bismuth, antimony, and nickel, but may further include copper (Cu), silver (Ag), and zinc (Zn). The weight percentage of tin is 62%˜63.5%. The weight percentage of lead is 36%˜37%. The weight percentage of bismuth is 0.0001%˜0.5%. The weight percentage of antimony is 0.0001%˜0.3%. The weight percentage of nickel is 0.0001%˜0.3%. The weight percentage of copper is 0.0001%˜0.05%. The weight percentage of silver is 0.0001%˜0.05%. The weight percentage of zinc is 0.0001%˜0.002%. The weight percentage of bismuth is greater than the weight percentage of antimony and nickel. The sum of the weight percentages of antimony and nickel is greater than the weight percentage of bismuth.

For example, the weight percentage of tin is 63.02%; the weight percentage of lead is 36.05%; the weight percentage of bismuth is 0.4%; the weight percentage of antimony is 0.3%; the weight percentage of nickel is 0.159%; the weight percentage of copper is 0.04%; the weight percentage of silver is 0.03%; the weight percentage of zinc is 0.001%. For example, the weight percentage of tin is 63.02%; the weight percentage of lead is 36.05%; the weight percentage of bismuth is 0.4%; the weight percentage of antimony is 0.3%; the weight percentage of nickel is 0.159%; the weight percentage of copper is 0.04%; the weight percentage of silver is 0.029%; the weight percentage of zinc is 0.002%.

The embodiment just exemplifies the disclosure and is not intended to limit the scope of the disclosure; any equivalent modification and variation according to the spirit of the disclosure is to be also included within the scope of the following claims and their equivalents.

The third embodiment of the present invention discloses that the alloy material MR of the alloy thermal fuse TS not only includes tin, lead, bismuth, antimony, nickel, copper, silver, and zinc, but may further include iron (Fe) and aluminum (Al). The weight percentage of tin is 62%˜63.5%. The weight percentage of lead is 36%˜37%. The weight percentage of bismuth is 0.0001%˜0.5%. The weight percentage of antimony is 0.0001%˜0.3%. The weight percentage of nickel is 0.0001%˜0.3%. The weight percentage of copper is 0.0001%˜0.05%. The weight percentage of silver is 0.0001%˜0.05%. The weight percentage of zinc is 0.0001%˜0.002%. The weight percentage of iron is 0.0001%˜0.002%. The weight percentage of aluminum is 0.0001%˜0.002%. The weight percentage of bismuth is greater than the weight percentage of antimony and nickel. The sum of the weight percentages of antimony and nickel is greater than the weight percentage of bismuth.

For example, the weight percentage of tin is 63.02%; the weight percentage of lead is 36.05%; the weight percentage of bismuth is 0.4%; the weight percentage of antimony is 0.3%; the weight percentage of nickel is 0.159%; the weight percentage of copper is 0.04%; the weight percentage of silver is 0.028%; the weight percentage of zinc is 0.001%; the weight percentage of iron is 0.001%; the weight percentage of aluminum is 0.001%. For example, the weight percentage of tin is 63.02%; the weight percentage of lead is 36.05%; the weight percentage of bismuth is 0.4%; the weight percentage of antimony is 0.3%; the weight percentage of nickel is 0.159%; the weight percentage of copper is 0.04%; the weight percentage of silver is 0.027%; the weight percentage of zinc is 0.002%; the weight percentage of iron is 0.001%; the weight percentage of aluminum is 0.001%.

The embodiment just exemplifies the disclosure and is not intended to limit the scope of the disclosure; any equivalent modification and variation according to the spirit of the disclosure is to be also included within the scope of the following claims and their equivalents.

The fourth embodiment of the present invention discloses that the alloy material MR of the alloy thermal fuse TS not only includes tin, lead, bismuth, antimony, nickel, copper, silver, zinc, iron, and aluminum, but may further include arsenic (As) and cadmium (Cd). The weight percentage of tin is 62%˜63.5%. The weight percentage of lead is 36%˜37%. The weight percentage of bismuth is 0.0001%˜0.5%. The weight percentage of antimony is 0.0001%˜0.3%. The weight percentage of nickel is 0.0001%˜0.3%. The weight percentage of copper is 0.0001%˜0.05%. The weight percentage of silver is 0.0001%˜0.05%. The weight percentage of zinc is 0.0001%˜0.002%. The weight percentage of iron is 0.0001%˜0.002%. The weight percentage of aluminum is 0.0001%˜0.002%. The weight percentage of arsenic is 0.0001%˜0.002%. The weight percentage of cadmium is 0.0001%˜0.002%. The weight percentage of bismuth is greater than the weight percentage of antimony and nickel. The sum of the weight percentages of antimony and nickel is greater than the weight percentage of bismuth. The weight percentage of copper is greater than that of any one of silver, zinc, iron, aluminum, arsenic, and cadmium. The weight percentage of silver is greater than that of any one of zinc, iron, aluminum, arsenic, and cadmium.

For example, the weight percentage of tin is 63.02%; the weight percentage of lead is 36.05%; the weight percentage of bismuth is 0.4%; the weight percentage of antimony is 0.3%; the weight percentage of nickel is 0.159%; the weight percentage of copper is 0.04%; the weight percentage of silver is 0.026%; the weight percentage of zinc is 0.001%; the weight percentage of iron is 0.001%; the weight percentage of aluminum is 0.001%; the weight percentage of arsenic is 0.001%; the weight percentage of cadmium is 0.001%. For example, the weight percentage of tin is 63.0012%; the weight percentage of lead is 36.9939%; the weight percentage of bismuth is 0.0013%; the weight percentage of antimony is 0.0009%; the weight percentage of nickel is 0.0009%; the weight percentage of copper is 0.0006%; the weight percentage of silver is 0.0005%; the weight percentage of zinc is 0.0001%; the weight percentage of iron is 0.0003%; the weight percentage of aluminum is 0.0001%; the weight percentage of arsenic is 0.0001%; the weight percentage of cadmium is 0.0001%. The specific gravity of the alloy thermal fuse TS may be 7.41. The solidus temperature of the alloy thermal fuse TS may be 183°. The liquidus temperature of the alloy thermal fuse TS may be 183°.

As described above, the alloy thermal fuse TS has a special composition ratio. As such, the alloy thermal fuse TS generates uniform heat when subjected to heat and has higher sensitivity to temperature changes, thereby improving the thermal conductivity of the alloy thermal fuse TS. Therefore, the alloy thermal fuse TS can melt and disconnect rapidly when heated. In addition, since the alloy thermal fuse TS has a structure of a strip-shaped alloy without an insulating housing or other complex components, no thermal loss will occur due to multiple media, thereby further enhancing the aforementioned technical effects.

The alloy thermal fuse TS can achieve the desired effectiveness under the premise of reduced cost. As such, the practicality of the alloy thermal fuse TS can be greatly improved, and the alloy thermal fuse TS can be applied to various different electronic devices to enhance the safety of these devices. Therefore, the alloy thermal fuse TS can meet the trend of future development.

The embodiment just exemplifies the disclosure and is not intended to limit the scope of the disclosure; any equivalent modification and variation according to the spirit of the disclosure is to be also included within the scope of the following claims and their equivalents.

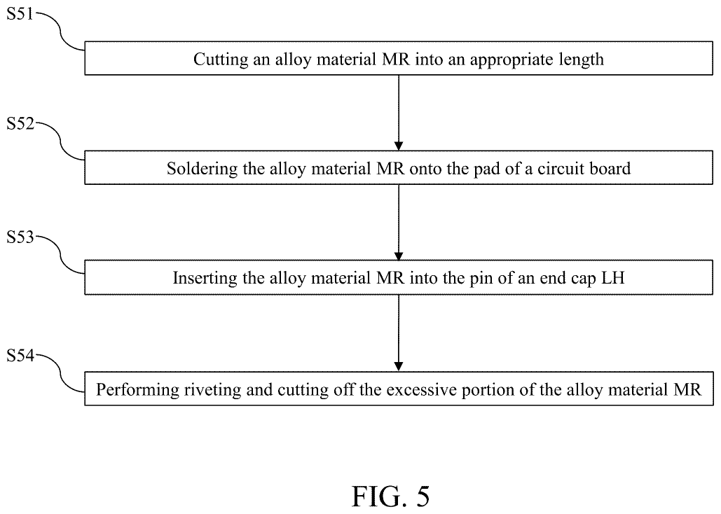

Please refer to FIG. 5, which is a flow chart of an installation method of an alloy thermal fuse in accordance with a second embodiment of the disclosure. As shown in FIG. 5, the installation method of the alloy thermal fuse in this embodiment includes the following steps:
Step S51: cutting the alloy material MR into an appropriate length.
Step S52: soldering the alloy material MR onto the pad of a circuit board.
Step S53: inserting the alloy material MR into the pin of the end cap LH.
Step S54: performing riveting and cutting off the excessive portion of the alloy material MR.

The embodiment just exemplifies the disclosure and is not intended to limit the scope of the disclosure; any equivalent modification and variation according to the spirit of the disclosure is to be also included within the scope of the following claims and their equivalents.

Although the operations of the method(s) herein are shown and described in a particular order, the order of the operations of each method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

To sum up, according to one embodiment of the present invention, the alloy thermal fuse TS is made of alloy material MR, and the alloy material MR includes tin, lead, bismuth, antimony, and nickel. The weight percentage of tin is 62% to 63.5%. The weight percentage of lead is 36% to 37%. The weight percentage of bismuth is 0.03% to 0.5%. The weight percentage of antimony is 0.03% to 0.3%. The weight percentage of nickel is 0.03% to 0.3%. The weight percentage of bismuth is greater than the weight percentages of antimony and nickel. The sum of the weight percentages of antimony and nickel is greater than the weight percentage of bismuth. Through the above specific component proportions, the alloy thermal fuse TS heats uniformly when exposed to heat, and exhibits higher sensitivity to temperature changes, thereby enhancing the thermal conductivity of the alloy thermal fuse TS. As a result, the alloy thermal fuse TS can melt quickly when heated. In addition, since the alloy thermal fuse TS has a structure of a single elongated alloy without an insulating casing or other complex components, the thermal fuse does not experience heat loss caused by various media, further improving the aforementioned technical effects.

According to one embodiment of the present invention, the alloy thermal fuse TS can be directly soldered onto a circuit board or semi-finished product, so the alloy thermal fuse TS will not prematurely lose the protective function thereof due to melting during wave soldering. Thus, the reliability of the alloy thermal fuse TS can be significantly enhanced to ensure that the alloy thermal fuse TS can properly provide temperature protection. Therefore, the alloy thermal fuse TS can meet practical application requirements.

Also, according to one embodiment of the present invention, the alloy thermal fuse TS has a structure of a single elongated alloy without an insulating casing or other complex components. The alloy thermal fuse TS also does not need to be fixed to the circuit board using adhesive. In this way, the alloy thermal fuse TS can be installed using automated equipment, greatly reducing installation cost and complexity. Therefore, the alloy thermal fuse TS can be more comprehensive in application, and can better meet the requirements of different applications.

In addition, according to one embodiment of the present invention, the alloy thermal fuse TS has a structure of a single elongated alloy without an insulating casing or other complex components. Therefore, the size of the alloy thermal fuse TS can be very small, without occupying internal space within the device. Consequently, the device can be more compact, which not only reduces manufacturing costs but also saves transportation costs.

Moreover, according to one embodiment of the present invention, the alloy thermal fuse TS has a specific component proportion. This specific component proportion allows the alloy thermal fuse TS to achieve excellent conductive performance. In this way, the alloy thermal fuse TS can provide temperature protection not only when the circuit board overheats but also when the circuit board experiences overcurrent. Therefore, the safety of the alloy thermal fuse TS can be greatly improved.

Furthermore, according to an embodiment of the present invention, the alloy thermal fuse TS can achieve the desired effect while reducing cost. As such, the practicality of the alloy thermal fuse TS can be significantly enhanced, and the alloy thermal fuse TS can be applied to various electronic devices while improving their safety. Therefore, the alloy thermal fuse TS can meet the trend of future development.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is

1. An alloy thermal fuse, wherein the alloy thermal fuse is made of an alloy material, the alloy material comprising a tin, a lead, a bismuth, an antimony, and a nickel, wherein a weight percentage of the tin is 62% to 63.5%, a weight percentage of the lead is 36% to 37%, a weight percentage of the bismuth is 0.0001% to 0.5%, a weight percentage of the antimony is 0.0001% to 0.3%, and a weight percentage of the nickel is 0.0001% to 0.3%.

2. The alloy thermal fuse as claimed in claim 1, wherein the weight percentage of the bismuth is greater than the weight percentage of the antimony and the weight percentage of the nickel.

3. The alloy thermal fuse as claimed in claim 1, wherein a sum of the weight percentage of the antimony and the weight percentage of the nickel is greater than the weight percentage of the bismuth.

4. The alloy thermal fuse as claimed in claim 1, wherein a specific gravity of the alloy material is between 7 and 8.

5. The alloy thermal fuse as claimed in claim 1, wherein the alloy material further comprises a copper, a silver, and a zinc, wherein a weight percentage of the copper is 0.0001% to 0.05%, a weight percentage of the silver is 0.0001% to 0.05%, and a weight percentage of the zinc is 0.0001% to 0.002%.

6. The alloy thermal fuse as claimed in claim 5, wherein the alloy material further comprises an iron and an aluminum, wherein a weight percentage of the iron is 0.0001% to 0.002%, and a weight percentage of the aluminum is 0.0001% to 0.002%.

7. The alloy thermal fuse as claimed in claim 6, wherein the alloy material further comprises an arsenic and a cadmium, wherein a weight percentage of the arsenic is 0.0001% to 0.002%, and a weight percentage of the cadmium is 0.0001% to 0.002%.

8. The alloy thermal fuse as claimed in claim 7, wherein the weight percentage any one of the bismuth, the antimony and the nickel is greater than the weight percentage of any one of the copper, the silver, the zinc, the iron, the aluminum, the arsenic, and the cadmium.

9. The alloy thermal fuse as claimed in claim 8, wherein the weight percentage of the copper is greater than the weight percentage of any one of the silver, the zinc, the iron, the aluminum, the arsenic, and the cadmium.

10. The alloy thermal fuse as claimed in claim 9, wherein the weight percentage of the silver is greater than the weight percentages of any one of the zinc, the iron, the aluminum, the arsenic, and the cadmium.
